(19) United States
(12) Patent Application Publication
(10) Pub. No.: US 2013/0004716 A1
(43) Pub. Date: Jan. 3, 2013

(54) PASTE, METHOD OF PREPARING SAME, AND ELECTRONIC DEVICE

(75) Inventors: Haeng Deog Koh, Hwaseong-si (KR); Eun Sung Lee, Seoul (KR); Sang Soo Jee, Hwaseong-si (KR); Jeong Na Heo, Hwaseong-si (KR); Suk Jun Kim, Suwon-si (KR); Se Yun Kim, Seoul (KR); Yun-Hyuk Choi, Seoul (KR)

(73) Assignee: SAMSUNG ELECTRONICS CO., LTD., Suwon-si (KR)

(21) Appl. No.: 13/477,500

(22) Filed: May 22, 2012

(30) Foreign Application Priority Data
Jul. 1, 2011 (KR) 10-2011-0065487

(51) Int. Cl. H01B 1/12; B32B 3/26; H01B 1/02

(52) U.S. Cl. 428/156; 252/500; 252/518.1; 252/519.34; 252/514; 252/512; 252/513

(57) ABSTRACT

A paste may include a functional water-soluble material, a surfactant surrounding the functional water-soluble material to form a reverse micelle structure, a binder, and a liposoluble organic solvent, and an electronic device including at least one of a pattern and an electrode may be formed using the paste.

### CROSS-REFERENCE TO RELATED APPLICATION

This application claims priority to and the benefit of Korean Patent Application No. 10-2011-0065487, filed in the Korean Intellectual Property Office, on Jul. 1, 2011, the entire contents of which are incorporated herein by reference.

### BACKGROUND

1. Field

Example embodiments provide a paste, a method of preparing the same, and an electronic device including the same.

2. Description of the Related Art

A process of manufacturing an electronic device may include etching a coating layer to form a predetermined pattern, doping, and forming an electrode.

The etching is performed by using a paste prepared based on phosphoric acid that can etch a silicon nitride (SiNₓ) anti-reflection coating layer through a chemical reaction. However, because a material, e.g., phosphoric acid, that can etch is mostly water soluble, an etching paste based on this material should include a water-soluble organic binder and solvent to prevent or reduce phase separation of the materials. In addition, selection of an additive, e.g., a plasticizer, used to control viscosity of a paste and/or a surfactant to disperse a conductive metal powder may be restricted.

### SUMMARY

Example embodiments provide a paste that stably includes a functional water-soluble material without phase separation from a binder, and a liposoluble organic solvent. Example embodiments provide a method of preparing the paste.

Example embodiments provide an electronic device that includes a pattern provided using the paste, an electrode provided using the paste, or a combination thereof.

According to example embodiments, a paste may include a functional water-soluble material, a surfactant, a binder, and a liposoluble organic solvent. The surfactant may surround the functional water-soluble material to form a reverse micelle structure.

The functional water-soluble material may include one selected from a water-soluble material having an etching property, a water-soluble material having a doping property, a water-soluble fluorescent dye material, a water-soluble conductive polymer material, a water-soluble metal salt, and a combination thereof.

The water-soluble material having an etching property may include one selected from phosphoric acid, hydrogen fluoride, sulfuric acid, ammonium fluoride, and a combination thereof.

The water-soluble material having a doping property may include one selected from boron salt, boron oxide, boric acid, an organic boron compound, a boron aluminum compound, phosphorous oxide, and a combination thereof.

The water-soluble fluorescent dye material may include one selected from a rhodamine dye, an acridine dye, a cyanine dye, a fluorone dye, an oxazine dye, a phenanthridine dye, and a combination thereof.

The water-soluble conductive polymer material may include one selected from polyaniline, polythiophene, polypyrrole, a derivative thereof, and a combination thereof.

The water-soluble metal salt may include one selected from HAuCl₄, AuCl₃, H₂PtCl₆, FeCl₃, CuCl₂, Zn(OAc)₂, AgNO₃, Ag(OAc), Pb(OAc)₂, CdCl₂, Cd(OAc)₂, and a combination thereof.

The reverse micelle structure may have an average diameter of about 1 nm to about 10 μm. The reverse micelle structure may be included in an amount of about 0.1 wt % to about 10 wt % based on a total amount of the paste.

The binder may include one selected from a cellulose-based resin, an acryl-based resin, a polyvinylacetal-based resin, a derivative thereof, and a combination thereof.

The liposoluble organic solvent may include one selected from N-methylpyrrolidone (NMP), ethylene glycol butyl ether, propylene carbonate, ethylene glycol, N-methyl-2-pyridone, ethylene glycol monoacetate, diethylene glycol, diethylene glycol acetate, tetraethylene glycol, propylene glycol, propylene glycol monomethyl ether, trimethylene glycol, glyceryl diacetate, hexylene glycol, dipropyl glycol, oxylene glycol, 1,2,6-hexanetriol, glycerine, butyl carbitol (BC), butyl carbitol acetate (BCA), methyl cellosolve, ethyl cellosolve, butyl cellosolve, aliphatic alcohol, α-terpineol, β-terpineol, dihydro terpineol, texanol, and a combination thereof.

The paste may include the surfactant in an amount ranging from about 30 parts by weight to about 500 parts by weight, the binder in an amount ranging from about 20 parts by weight to about 1000 parts by weight, and the liposoluble organic solvent in an amount ranging from about 100 parts by weight to about 5000 parts by weight based on 100 parts by weight of the functional water-soluble material.

The paste may further include a conductive powder, and the reverse micelle structure may be on an exposed surface of the conductive powder. The conductive powder may include silver (Ag), aluminum (Al), copper (Cu), nickel (Ni), tin (Sn), cobalt (Co), palladium (Pd), lead (Pb), alloys thereof, oxides thereof, and a combination thereof.

The conductive powder may be included in an amount ranging from about 30 wt % to about 99 wt % based on a total amount of the paste including the conductive powder. The paste may further include at least one of a glass frit and a metallic glass. Herein, the paste may include the at least one of the glass frit and the metallic glass in an amount ranging from about 0.1 wt % to about 15 wt % based on a total amount of the paste including the at least one of the glass frit and the metallic glass.

The paste may further include a plasticizer. Herein, the plasticizer may be included in an amount ranging from about 0.1 wt % to about 15 wt % based on a total amount of the paste including the plasticizer.

The paste may be dried at a temperature ranging from about 100° C. to about 400° C.

The paste may be baked at a temperature ranging from about 500° C. to about 900° C.

According to example embodiments, a method of manufacturing a paste may include forming a first mixture by mixing a functional water-soluble material, a surfactant, and a first liposoluble organic solvent to form a first mixture, and adding one of a binder and a mixture of the binder and a second liposoluble organic solvent to the first liposoluble organic solvent. The first mixture may include a reverse micelle structure where the functional water-soluble material is surrounded by the surfactant in the first liposoluble organic solvent.

The method may further include adding a material selected from a conductive powder, a glass frit, a metallic glass, a plasticizer, and a combination thereof to the first liposoluble organic solvent at the same time as the adding one of the binder and the mixture of the binder and the second liposoluble organic solvent.

According to example embodiments, an electronic device may include at least one of a pattern and an electrode formed using the aforementioned paste.

The electrode may have contact resistance ranging from about 1 μΩcm² to about 10 Ωcm². The electrode may have resistivity ranging from about 0.1 μΩcm to about 100 μΩcm.

### BRIEF DESCRIPTION OF THE DRAWINGS

These and/or other aspects will become apparent and more readily appreciated from the following description of example embodiments, taken in conjunction with the accompanying drawings of which:

FIG. 1 provides a schematic diagram of a liposoluble organic solvent including a reverse micelle structure according to example embodiments.

FIG. 2 is a schematic diagram showing a paste according to example embodiments.

FIG. 3 is a cross-sectional view of a solar cell according to example embodiments.

FIG. 4 is a turbidity graph of a mixture including a reverse micelle structure according to Example 1.

FIG. 5 is a TEM image of a dry mixture including a reverse micelle structure according to Example 1.

FIG. 6A is an optical photograph of a pattern formed using the paste according to Example 1, FIG. 6B is an optical microscope photograph of a pattern formed using the paste according to Example 1, and FIG. 6C is a 20-times-enlarged view of the part X in FIG. 6B.

FIG. 7 is an Auger electron spectroscopy analysis graph of a silicon wafer according to Example 6.

FIG. 8 is an Auger electron spectroscopy analysis graph of the silicon wafer of Example 6 after forming an insulation layer thereon.

FIG. 9 is an Auger electron spectroscopy analysis graph of the part A in FIG. 6B.

### DETAILED DESCRIPTION

Example embodiments will hereinafter be described in detail and may be easily performed by those who have common knowledge in the related art. This disclosure may, however, be embodied in many different forms and should not be construed as limited to the example embodiments set forth herein.

In the drawings, the thickness of layers, films, panels, regions, etc., are exaggerated for clarity. Like reference numerals designate like elements throughout the specification. It will be understood that when an element such as a layer, film, or substrate is referred to as being “on” another element, it can be directly on the other element or intervening elements may also be present.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

A conductive paste according to example embodiments is illustrated. The conductive paste according to example embodiments may include a functional water-soluble material (e.g., a functional hydrophilic material), a surfactant, a binder, and a liposoluble organic solvent (e.g., a hydrophobic organic solvent). The paste may include a reverse micelle structure, and the functional water-soluble material may be surrounded by the surfactant.

The paste including this reverse micelle structure may effectively disperse a water-soluble functional material without phase separation into a liposoluble organic solvent. In addition, the functional water-soluble material may break down into nano-size to micro-size units due to the reverse micelle structure. Accordingly, the functional water-soluble material may efficiently function therein. Furthermore, because various materials dispersed in a liposoluble organic solvent may be easily added to the paste, the paste may be applied to various other uses.

The functional water-soluble material may include one selected from a water-soluble material having an etching property, a water-soluble material having a doping property, a water-soluble fluorescent dye material, a water-soluble conductive polymer material, a water-soluble metal salt, and a combination thereof.

The water-soluble material having an etching property may include one selected from phosphoric acid, hydrogen fluoride, sulfuric acid, ammonium fluoride, and a combination thereof, but is not limited thereto.

The water-soluble material having a doping property may include one selected from a boron salt, boron oxide, boric acid, an organic boron compound, a boron aluminum compound, phosphorous oxide, and a combination thereof, but is not limited thereto.

The water-soluble fluorescent dye material may include one selected from a rhodamine dye, an acridine dye, a cyanine dye, a fluorone dye, an oxazine dye, a phenanthridine dye, and a combination thereof, but is not limited thereto.

The water-soluble conductive polymer material may include one selected from polyaniline, polythiophene, polypyrrole, a derivative thereof, and a combination thereof, but is not limited thereto.

The water-soluble metal salt may include one selected from HAuCl₄, AuCl₃, H₂PtCl₆, FeCl₃, CuCl₂, Zn(OAc)₂, AgNO₃, Ag(OAc), Pb(OAc)₂, CdCl₂, Cd(OAc)₂, and a combination thereof, but is not limited thereto.

The surfactant may be an amphiphilic material including a water-soluble functional group and a liposoluble functional group, and may surround the functional water-soluble material in the paste, thereby helping the functional water-soluble material effectively disperse into the liposoluble organic solvent without phase separation.

In particular, the surfactant may include a water-soluble head part including a water-soluble functional group, e.g., —PO₄H₂, —SO₃⁻, —COOH, and —OH, and a liposoluble tail part including a liposoluble functional group, e.g., a C1 to C50 alkyl group and a C6 to C50 aryl group, but are not limited thereto.

For example, the surfactant may include a compound represented by the following Chemical Formula 1, sodium bis(2-ethylhexyl)sulfosuccinate represented by the following Chemical Formula 2, a compound represented by the following Chemical Formula 3, glycolic acid ethoxylate 4-nonylphenyl ether, sodium dodecyl sulfate, potassium persulfate, and a combination thereof, but is not limited thereto.

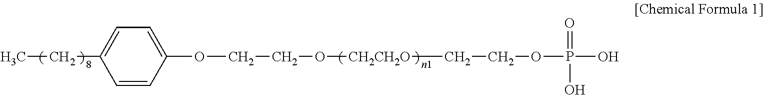

In Chemical Formula 1, wherein n1 is an integer ranging from 1 to 20.

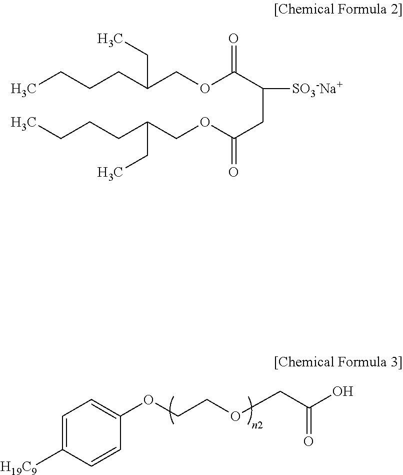

In Chemical Formula 3, wherein n2 is an integer ranging from 1 to 20.

The functional water-soluble material and the surfactant may form a reverse micelle structure in a microemulsion state.

The reverse micelle structure may have an average diameter of about 1 nm to about 10 μm. When the reverse micelle structure has an average diameter within the range, the reverse micelle structure may have desirable stability and thermal properties. Accordingly, when the reverse micelle structure is exposed to a binder and a liposoluble organic solvent, the reverse micelle structure may be stably maintained without a phase separation. In addition, a solution including the reverse micelle structure may be transparent.

The reverse micelle structure may be included in an amount of about 0.1 wt % to about 10 wt % based on the total amount of the paste. When the reverse micelle structure is included within the range, the reverse micelle structure may be effectively dispersed in the paste and effectively realize properties of the functional water-soluble material. In particular, the reverse micelle structure may be included in an amount of about 0.5 wt % to about 5 wt %, and in particular, about 1 wt % to about 5 wt % based on the total amount of the paste.

The binder plays a role of a matrix for dispersing the reverse micelle structure and the following conductive powder, and may include one selected from a cellulose-based resin, an acryl-based resin, a polyvinylacetal-based resin, a derivative thereof, and a combination thereof, but is not limited thereto.

Particularly, the binder may include one selected from ethylcellulose, polyvinylpyrrolidone, nylon-6, nitrocellulose, gelatine, polyvinylbutyral, a polyimide resin, polyether-polyols, polyetherurea-polyurethane, and a derivative thereof, but is not limited thereto.

The liposoluble organic solvent may be a material that dissolves or disperses components of the paste, and may include N-methylpyrrolidone (NMP), ethylene glycol butyl ether, propylene carbonate, ethylene glycol, N-methyl-2-pyridone, ethylene glycol monoacetate, diethylene glycol, diethylene glycol acetate, tetraethylene glycol, propylene glycol, propylene glycol monomethyl ether, trimethylene glycol, glyceryl diacetate, hexylene glycol, dipropyl glycol, oxylene glycol, 1,2,6-hexanetriol, glycerine, butyl carbitol (BC), butyl carbitol acetate (BCA), methyl cellosolve, ethyl cellosolve, butyl cellosolve, aliphatic alcohol, α-terpineol, β-terpineol, dihydro terpineol, texanol, and a combination thereof, but is not limited thereto.

The paste may include about 30 parts by weight to about 500 parts by weight of the surfactant, about 20 parts by weight to about 1000 parts by weight of the binder, and about 100 parts by weight to about 5000 parts by weight of the liposoluble organic solvent based on 100 parts by weight of the functional water-soluble material. When the paste includes components within the range, a water-soluble functional material may have a reverse micelle structure and stably maintain the structure, which may accordingly prevent or reduce phase separation among materials and effectively control viscosity of the paste. In addition, the paste may more easily include a conductive powder. Particularly, the paste may include about 30 parts by weight to about 300 parts by weight of the surfactant, about 20 parts by weight to about 700 parts by weight of the binder, and about 100 parts by weight to about 2000 parts by weight of the liposoluble organic solvent based on 100 parts by weight of the functional water-soluble material, and more particularly, about 30 parts by weight to about 250 parts by weight of the surfactant, about 100 parts by weight to about 700 parts by weight of the binder, and about 120 parts by weight to about 2000 parts by weight of the liposoluble organic solvent based on 100 parts by weight of the functional water-soluble material.

The paste may further include a conductive powder. When the paste further includes this conductive powder, the paste may perform a role of forming an electrode as well as secure a function of the functional water-soluble material.

When the paste further includes the conductive powder, the reverse micelle structure may surround the surface of the conductive powder. The conductive powder may include a metal with resistivity of about 100 μΩcm or less.

Particularly, the conductive powder may include a silver (Ag)-containing metal, e.g., silver or a silver alloy, an aluminum (Al)-containing metal, e.g., aluminum or an aluminum alloy, a copper (Cu)-containing metal, e.g., copper or a copper alloy, a nickel (Ni)-containing metal, e.g., nickel or a nickel alloy, a tin (Sn)-containing metal, e.g., tin or a tin alloy, a cobalt (Co)-containing metal, e.g., cobalt or a cobalt alloy, a palladium (Pd)-containing metal, e.g., palladium or a palladium alloy, a lead (Pb)-containing metal, e.g., lead or a lead alloy, alloys of two or more of the foregoing metals, oxides thereof, or a combination thereof, but is not limited thereto.

The conductive powder may have a diameter ranging from about 1 nm to about 50 μm. When the conductive powder has an average diameter within the range, the paste may be easily sintered during baking and improve properties of an electrode through mechanism of electronic transition, as well as effectively forming an electrode. Particularly, the conductive powder may have an average diameter of about 10 nm to about 30 μm.

The paste may include the conductive powder in an amount ranging from about 30 wt % to about 99 wt % based on the total amount of the paste including the conductive powder. When the conductive powder is included within the range, an electrode may have a larger aspect ratio, and a paste may be effectively controlled regarding viscosity and ease of screen printing. Particularly, the paste may include the conductive powder in an amount of about 50 wt % to about 90 wt % based on the total amount of the paste including the conductive powder.

The paste may further include glass frit, metallic glass, or a combination thereof. The glass frit has an improved etching property for an insulation layer, and may be used to etch an insulation layer, e.g., an anti-reflection coating layer, for a solar cell. Furthermore, the glass frit has an improved close contacting property with a lower layer, thereby improving adherence to the lower layer.

The glass frit may include one selected from PbO—SiO₂-based glass, PbO—SiO₂—B₂O₃-based glass, PbO—SiO₂—B₂O₃—ZnO-based glass, PbO—SiO₂—B₂O₃—BaO-based glass, PbO—SiO₂—ZnO—BaO-based glass, ZnO—SiO₂-based glass, ZnO—B₂O₃—SiO₂-based glass, ZnO—K₂O—B₂O₃—SiO₂—BaO-based glass, Bi₂O₃—SiO₂-based glass, Bi₂O₃—B₂O₃—SiO₂-based glass, Bi₂O₃—B₂O₃—SiO₂—BaO-based glass, ZnO—BaO—B₂O₃—P₂O₅—Na₂O-based glass, Bi₂O₃—B₂O₃—SiO₂—BaO—ZnO-based glass, and a combination thereof, but is not limited thereto.

The metallic glass may be an alloy including two or more metals and having a disorderly atomic structure, and may be called an amorphous metal. The metallic glass has lower resistivity, unlike common glass, e.g., silicate, and thus has conductivity. Particularly, the metallic glass may be bulk metallic glass (BMG).

The metallic glass may include a transition metal, a noble metal, a rare earth element metal, an alkaline-earth metal, a semimetal, an alloy thereof and a combination thereof, for example, at least one alloy including one selected from copper (Cu), titanium (Ti), nickel (Ni), aluminum (Al), zirconium (Zr), iron (Fe), magnesium (Mg), calcium (Ca), cobalt (Co), palladium (Pd), platinum (Pt), gold (Au), cerium (Ce), lanthanum (La), yttrium (Y), gadolinium (Gd), beryllium (Be), tantalum (Ta), gallium (Ga), hafnium (Hf), niobium (Nb), lead (Pb), platinum (Pt), silver (Ag), phosphorus (P), boron (B), silicon (Si), carbon (C), tin (Sn), zinc (Zn), molybdenum (Mo), tungsten (W), manganese (Mn), erbium (Er), chromium (Cr), praseodymium (Pr), thulium (Tm), and a combination thereof.

Particularly, the metallic glass may be an alloy including at least one selected from copper (Cu), zirconium (Zr), nickel (Ni), aluminum (Al), iron (Fe), titanium (Ti), magnesium (Mg), and a combination thereof among the forgoing metals.

The paste may include the glass frit, metallic glass, or a combination thereof in an amount ranging from about 0.1 wt % to about 15 wt % based on the total amount of the paste including the glass frit, metallic glass, or combination thereof. When the glass frit, metallic glass, or combination thereof is included within the range, a baked electrode may be formed to have improved adherence to a lower layer through melting and wetting processes during the baking. In addition, when a conductive powder is used together with the glass frit, metallic glass, or combination thereof, the conductive powder may be easily adhered thereto. Particularly, the paste may include the glass frit, metallic glass, or combination thereof in an amount ranging from about 0.3 wt % to about 10 wt % based on the total amount of the paste including the glass frit, metallic glass, or combination thereof.

The paste may further include a plasticizer. The plasticizer may control viscosity of the paste. The plasticizer may include one selected from diethyl phthalate (DEP), dioctyl phthalate (DOP), dibutyl phthalate (DBP), diisodecyl phthalate (DINP), 2-ethylhexyldiphenyl phosphate (octicizer), tricresyl phosphate (TCP), tri(2-ethylhexyl)phosphate (TOP), cresyl diphenyl phosphate (CDP), and a combination thereof, but is not limited thereto.

The paste may include the plasticizer in an amount ranging from about 0.1 wt % to about 15 wt % based on the total amount of the paste including the plasticizer. When the plasticizer is included within the range, a water-soluble functional material may effectively maintain a reverse micelle structure without phase separation. Accordingly, the water-soluble functional material may accomplish desired effects. Particularly, the paste may include the plasticizer in an amount ranging from about 0.1 wt % to about 10 wt % based on the total amount of the paste including the plasticizer.

In addition, the paste may further include an additive, e.g., a thickener, an antifoaming agent, a thixotropy agent, a dispersing agent, a leveling agent, an antioxidant, and/or a thermal polymerization inhibitor, to improve viscosity and dispersion properties.

A conventional paste may have an etching property due to a reaction between lead oxide (PbO) and the components of the glass frit and an anti-reflection coating layer, which may be acquired at a temperature of about 700° C. or higher.

According to example embodiments, a paste may be dried at a temperature ranging from about 100° C. to about 400° C. In addition, when a water-soluble material having an etching property is used as the functional water-soluble material, the etching may be effectively performed within the temperature range. Particularly, the paste may be dried at a temperature ranging from about 200° C. to about 400° C.

In addition, the paste may be baked at a temperature ranging from about 500° C. to about 900° C. to form an electrode after the drying or the drying and etching. Particularly, the paste may be baked at a temperature ranging from about 500° C. to about 800° C. to form an electrode after the drying or the drying and etching.

In this way, a paste according to example embodiments may effectively secure a functional water-soluble material without a heat treatment at a relatively high temperature, and may easily form an electrode.

According to example embodiments, a method of manufacturing the paste may include mixing a functional water-soluble material, a surfactant, and a liposoluble organic solvent to form a reverse micelle structure in which the surfactant surrounds the functional water-soluble material in the liposoluble organic solvent, and adding a binder or a mixture of the binder with a liposoluble organic solvent to the liposoluble organic solvent including the reverse micelle structure.

The method of manufacturing the paste may effectively disperse and stably maintain the reverse micelle structure without phase separation by forming the reverse micelle structure in a liposoluble organic solvent and mixing the reverse micelle structure with an organic vehicle (OV) including a binder or a mixture of the binder and a liposoluble organic solvent.

On the other hand, when the functional water-soluble material, surfactant, liposoluble organic solvent, and binder are simultaneously mixed, the materials may demonstrate phase separation, not form a reverse micelle structure including the functional water-soluble material, and fail to effectively prepare a paste.

The functional water-soluble material, surfactant, liposoluble organic solvent, reverse micelle structure, and binder may be the same as aforementioned unless specifically illustrated.

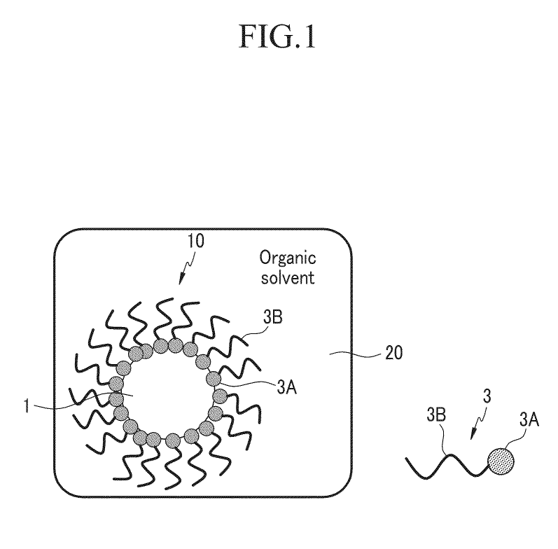

FIG. 1 provides a schematic diagram showing a liposoluble organic solvent including a reverse micelle structure according to example embodiments.

Referring to FIG. 1, a reverse micelle structure 10 including a functional water-soluble material 1 and a surfactant 3 surrounding the functional water-soluble material 1 may be dispersed in the liposoluble organic solvent 20. The surfactant 3 includes a water-soluble head part 3A and a liposoluble tail part 3B.

The method may further include the addition of a conductive powder, a glass frit, a metallic glass, a plasticizer, or a combination thereof when a binder or a mixture of the binder with a liposoluble organic solvent is added to the liposoluble organic solvent including the reverse micelle structure to prepare a paste as previously described. Hereinafter, the conductive powder, glass frit, metallic glass, and plasticizer may be the same as previously described.

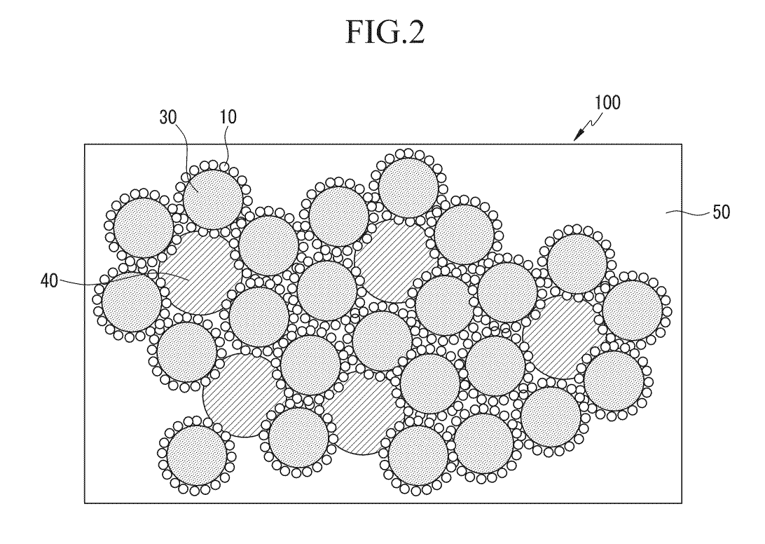

FIG. 2 provides a schematic diagram of a paste according to example embodiments. Referring to FIG. 2, the paste 100 includes: conductive powder 30, a reverse micelle structure 10 on the surface of the conductive powder 30, a metallic glass 40 among the conductive powder 30 including the reverse micelle structure 10 on the surface thereof, and an organic vehicle 50 including a liposoluble organic solvent (not shown) and a binder (not shown).

According to example embodiments, an electronic device including a pattern, an electrode, or a combination thereof formed using the paste is provided.

Particularly, the electronic device may include a solar cell, a plasma display panel (PDP), an organic light-emitting diode (OLED) display, and/or a radio frequency identification (RFID) tag, but is not limited thereto. The heat treatment to form a pattern and an electrode using the paste may be performed in two steps.

The first step is for drying and simultaneously etching an anti-reflective coating (ARC) layer using the paste to form a pattern, and the drying and etching process is performed at a temperature ranging from about 100° C. to about 400° C. to evaporate a liposoluble organic solvent and to allow for the ARC layer to be etched through a chemical reaction between the ARC layer and a water-soluble material having an etching property. Accordingly, the paste may allow for the etching process at a lower temperature than a conventional paste including a glass frit, thereby preventing or reducing damage to an emitter.

The second heat-treatment is performed to form an electrode at a temperature ranging from about 500° C. to about 900° C. after the drying and etching step. Unlike a conventional paste, a paste according to example embodiments may effectively include conductive powder and the like and form an electrode by controlling the temperature in the heat treatment without an additional process after the etching. When a conventional paste is used to form an electrode, an electrode paste is coated on the etched region by using a mask and is then additionally heat-treated after etching.

An electrode formed using the paste may have contact resistance ranging from about 1 μΩcm² to about 10 Ωcm². When the electrode has contact resistance within the range, an electronic device including the electrode, in particular, a solar cell, may have an improved fill factor (FF) and photoelectric conversion efficiency. In particular, the electrode may have contact resistance ranging from about 1 mΩcm² to about 1000 mΩcm², and in particular, about 1 mΩcm² to about 10 mΩm².

An electrode formed using the paste may have resistivity ranging from about 0.1 μΩcm to about 100 μΩcm. When the electrode has resistivity within the range, an electronic device including the electrode, and in particular, a solar cell, may have an improved fill factor (FF) and photoelectric conversion efficiency. In particular, the electrode may have resistivity ranging from about 1 μΩcm to about 100 μΩcm, particularly, from about 1 μΩcm to about 10 μΩcm, more particularly, about 2 μΩcm to about 6.5 μΩcm, and much more particularly, about 2 μΩcm to about 4 μΩcm.

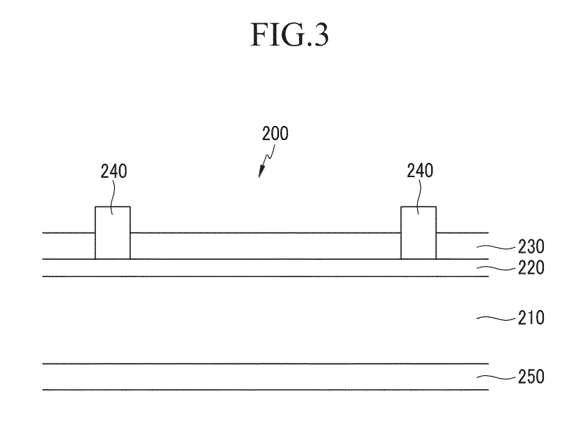

A solar cell among the electronic devices is illustrated referring to FIG. 3. FIG. 3 is the cross-sectional view of a solar cell 200 according to example embodiments. Hereinafter, “front side” of a semiconductor substrate 210 refers to the side receiving solar energy, and “rear side” refers to the side opposite the front side. Hereinafter, for better understanding and ease of description, the upper and lower positional relationship is described with respect to the semiconductor substrate 210, but is not limited thereto.

Referring to FIG. 3, the solar cell 200 may include the semiconductor substrate 210, an emitter layer 220 formed on the front side of the semiconductor substrate 210, a first electrode 240 formed on a first region of the front side of the emitter layer 220, an anti-reflection coating layer 230 formed on a second region of the front side of the emitter layer apart from the first electrode 240, and a second electrode 250 formed on the rear side of the semiconductor substrate 210.

Herein, the paste may be used in a process of etching the first region of the anti-reflection coating 230 where the first electrode 240 is to be formed in order to form a pattern, or in all of the processes. The paste may be coated at a desired place by a screen-printing method.

### EXAMPLES

The following examples illustrate this disclosure in more detail. However, this disclosure is not limited by these examples.

### Example 1

### Preparation of Paste

A reverse micelle structure including a functional phosphoric acid is prepared. About 1 g of a RE610 surfactant (made by Gafac) represented by the following Formula 1-1 is dispersed in about 40 g of a solvent prepared by mixing butyl carbitol (BC)/butyl carbitol acetate (BCA) in a weight ratio of about 7:3. About 10 g of an 85% phosphoric acid aqueous solution is added to the mixture. The resulting mixture is dispersed to prepare a mixture having the reverse micelle structure in which a —PO₄H₂ group, a water-soluble head part of the RE610 surfactant, is pointing toward the phosphoric acid aqueous solution, and an alkyl group, a liposoluble tail part, is pointing toward the BC/BCA mixed solvent to encapsulate the phosphoric acid aqueous solution.

On the other hand, an organic vehicle is prepared by adding about 30 g of an ethylcellulose binder (STD series) to about 70 g of a solvent prepared by mixing butyl carbitol (BC)/butyl carbitol acetate (BCA) in a weight ratio of about 7:3.

About 1.5 g of the mixture including a reverse micelle structure is mixed with about 6.5 g of the organic vehicle, and 40 g of silver (Ag) powder with an average diameter of about 2 μm or less, about 1 g of Cu-based metallic glass, about 1 g of diethyl phthalate (DEP), and about 0.7 g of glycolic acid ethoxylate 4-nonylphenyl ether are added thereto. The mixture is uniformly mixed in a 3-roll milling method to prepare a paste.

The reverse micelle structure is included in an amount of about 0.64 wt % based on the total amount of the paste.

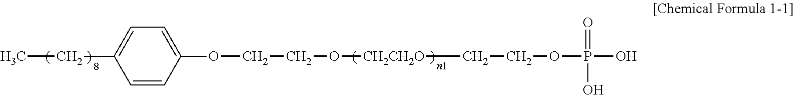

In Chemical Formula 1-1, wherein n1 is an integer ranging from 1 to 20.

### Example 2

### Preparation of Paste

A paste is prepared according to the same method as Example 1 except for mixing about 4 g of the mixture having a reverse micelle structure with about 4 g of the organic vehicle.

The reverse micelle structure paste is included in an amount of about 1.7 wt % based on the total amount of the paste.

### Example 3

### Preparation of Paste

A paste is prepared according to the same method as Example 1 except for using Zr-based metallic glass instead of Cu-based metallic glass.

### Example 4

### Preparation of Paste

A paste is prepared according to the same method as Example 1 except for using Al-based metallic glass instead of Cu-based metallic glass.

### Example 5

### Preparation of Paste

A reverse micelle structure including a water-soluble metal salt is prepared. About 1 g of a RE610 surfactant (made by Gafac) represented by the following Formula 1-1 is dispersed in about 40 g of a solvent prepared by mixing butyl carbitol (BC)/butyl carbitol acetate (BCA) in a weight ratio of 7:3. About 8 g of a 30 wt % AgNO₃ aqueous solution is added to the mixture. The resulting mixture is dispersed to include a reverse micelle structure in which the AgNO₃ aqueous solution is encapsulated.

A paste is prepared according to the same method as Example 1 except for mixing about 4 g of the mixture having a reverse micelle structure including the functional phosphoric acid with about 4 g of the organic vehicle according to Example 1 and adding about 3 g of the mixture including AgNO₃ thereto.

The reverse micelle structure including the functional phosphoric acid according to Example 1 is included in an amount of about 1.5 wt % based on the total amount of the paste, and the reverse micelle structure including AgNO₃ is included in an amount of about 1.0 wt % based on the total amount of the paste.

### Comparative Example 1

### Preparation of Paste

A paste is prepared according to the same method as Example 1 except for using about 1.5 g of PbO—SiO₂—B₂O₃-based glass instead of about 1.5 g of the mixture including a reverse micelle structure.

The PbO—SiO₂—B₂O₃-based glass is included in an amount of about 3 wt % based on the total amount of the paste.

### Comparative Example 2

### Preparation of Paste

About 0.5 ml of 85% phosphoric acid aqueous solution is mixed with about 7.5 g of the organic vehicle according to Example 1. About 40 g of silver (Ag) powder with an average diameter of 2 μm or less, 1 g of Cu-based metallic glass, about 1 g of diethyl phthalate (DEP), and about 0.7 g of glycolic acid ethoxylate 4-nonylphenyl ether are added thereto. The mixture is uniformly mixed in a 3-roll milling method, preparing a paste.

### Example 6

### Fabrication of Electrode

A p-type silicon wafer is prepared. Phosphoryl trichloride (POCl₃) is doped at about 3×10²¹ atom/cm³ on one side of the p-type silicon wafer to form an emitter layer. Herein, the emitter layer has a sheet resistance of about 1000 Ω/sq on the silicon wafer.

Silicon nitride (Si₃N₄) is anti-reflection-coated to form an about 80 nm-thick insulation layer on the emitter layer in a plasma enhanced chemical vapor deposition (PECVD) method.

The paste of Example 1 is coated on a part of the insulation layer where an electrode is to be formed in a screen-printing method. The insulation layer is etched by heating the coated paste to about 300° C. and maintaining it for about 5 minutes in a belt furnace, and then dried.

The dried product is baked by heating it to about 600° C. and maintaining it for about 4 minutes in a belt furnace. The baked product is cooled to form an electrode.

### Example 7

### Fabrication of Electrode

An electrode is formed according to the same method as Example 6 except for performing the second heat-treatment at about 650° C. instead of about 600° C.

### Example 8

### Fabrication of Electrode

An electrode is formed according to the same method as Example 6 except for using the paste of Example 2 instead of the paste of Example 1.

### Example 9

### Fabrication of Electrode

An electrode is formed according to the same method as Example 6 except for using the paste of Example 2 instead of the paste of Example 1 and performing the second heat-treatment at about 650° C. instead of about 600° C.

### Example 10

### Fabrication of Electrode

An electrode is formed according to the same method as Example 6 except for using the paste of Example 3 instead of the paste of Example 1.

### Example 11

### Fabrication of Electrode

An electrode is formed according to the same method as Example 6 except for using the paste of Example 3 instead of the paste of Example 1 and performing the second heat-treatment at about 650° C. instead of about 600° C.

### Example 12

### Fabrication of Electrode

An electrode is formed according to the same method as Example 6 except for using the paste of Example 4 instead of the paste of Example 1.

### Example 13

### Fabrication of Electrode

An electrode is formed according to the same method as Example 6 except for using the paste of Example 4 instead of the paste of Example 1 and performing the second heat-treatment at about 650° C. instead of about 600° C.

### Example 14

### Fabrication of Electrode

An electrode is formed according to the same method as Example 6 except for using the paste of Example 5 instead of the paste of Example 1.

### Example 15

### Fabrication of Electrode

An electrode is formed according to the same method as Example 6 except for using the paste of Example 5 instead of the paste of Example 1 and performing the second heat-treatment at about 650° C. instead of about 600° C.

### Comparative Example 3

### Fabrication of Electrode

An electrode is formed according to the same method as Example 6 except for using the paste of Comparative Example 1 instead of the paste of Example 1.

### Comparative Example 4

### Fabrication of Electrode

An electrode is formed according to the same method as Example 6 except for using the paste of Comparative Example 2 instead of the paste of Example 1.

### Experimental Example 1

### Turbidity Measurement

The mixture including a reverse micelle structure according to Example 1 is measured regarding turbidity using Turbi scan equipment.

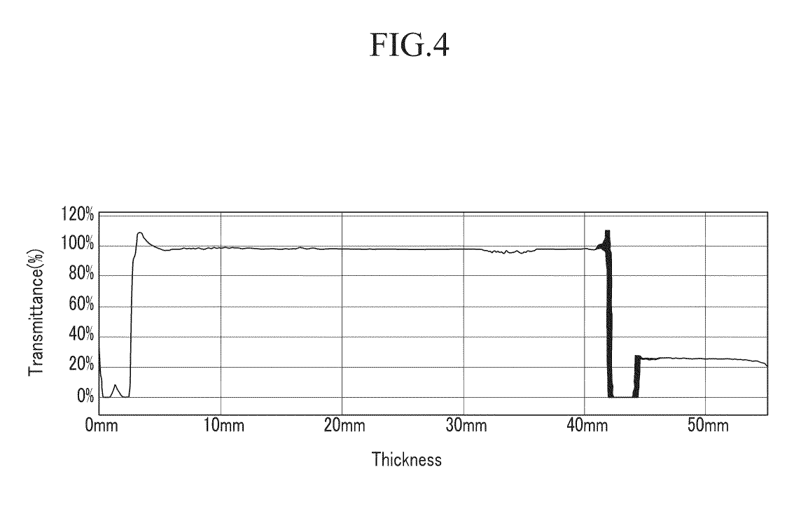

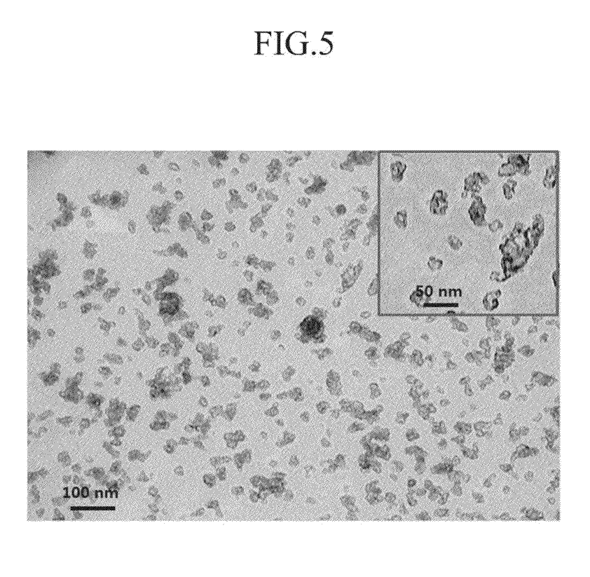

The result is provided in FIG. 4. In FIG. 4, the horizontal axis indicates the thickness of a specimen formed by coating the mixture including a reverse micelle structure, while the vertical axis indicates a transmittance.

As shown in FIG. 4, a mixture including a reverse micelle structure according to Example 1 is identified as a transparent W/O (water-in-oil) microemulsion with improved thermal stability.

### Experimental Example 2

### Transmission Electron Microscope (TEM) image

The mixture including a reverse micelle structure according to Example 1 is dried to evaporate a solvent, and a transmission electron microscope image of the mixture is obtained by using FE-TEM (200 kV/G2) equipment.

The result is provided in FIG. 5. As shown in FIG. 5, the mixture is identified to have a hollow reverse micelle structure of Example 1.

### Experimental Example 3

### Selective Patterning

The insulation layer is etched and dried as performed in Example 6, and then cleaned using a nitric acid (HNO₃) aqueous solution. The pattern is examined with an optical microscope (OM) (Hitachi, Ltd.).

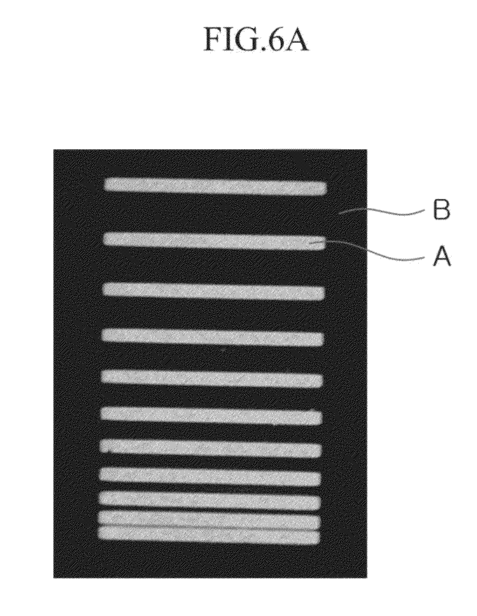

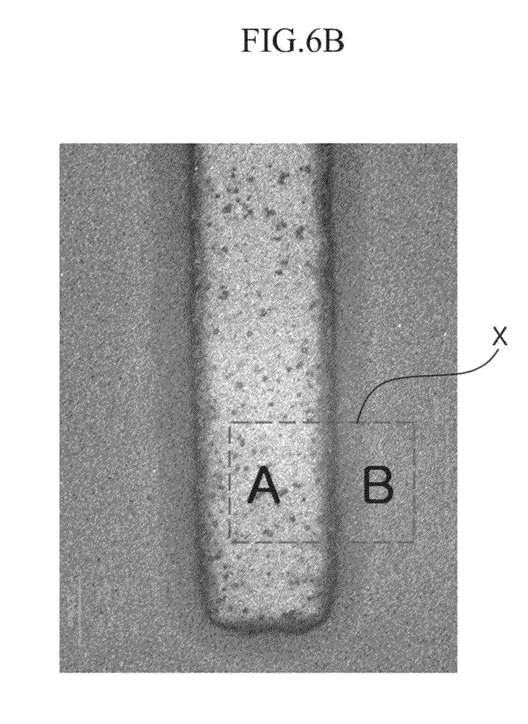

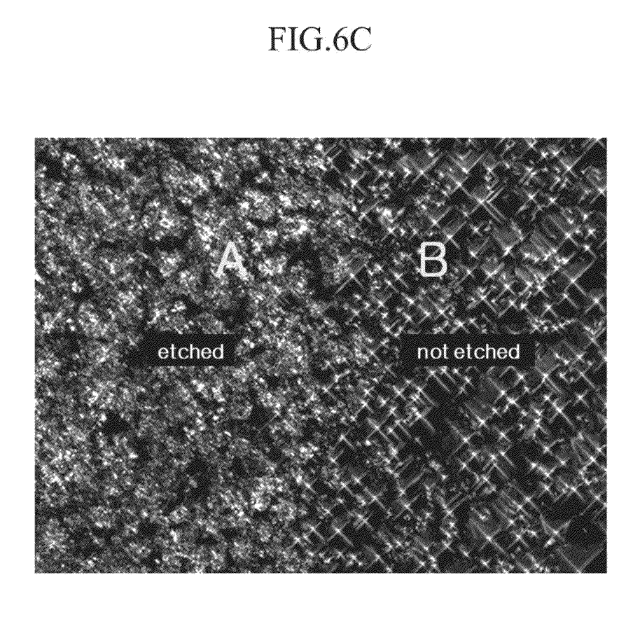

FIG. 6A shows an optical photograph of the pattern, FIG. 6B shows an optical microscope photograph of the pattern, and FIG. 6C shows a 20-times-enlarged view of the X part in FIG. 6B.

In FIGS. 6A to 6C, the A part indicates a patterned region while the B part indicates a remaining insulation layer.

As shown in FIGS. 6B and 6C, an insulation layer is selectively etched in the region coated with the paste of Example 1, while the insulation layer is not etched but remains in the region not coated with the paste of Example 1. In particular, the part marked as “not etched” in FIG. 6C shows a Si₃N₄ lattice forming an insulation layer.

### Experimental Example 4

### Surface Analysis

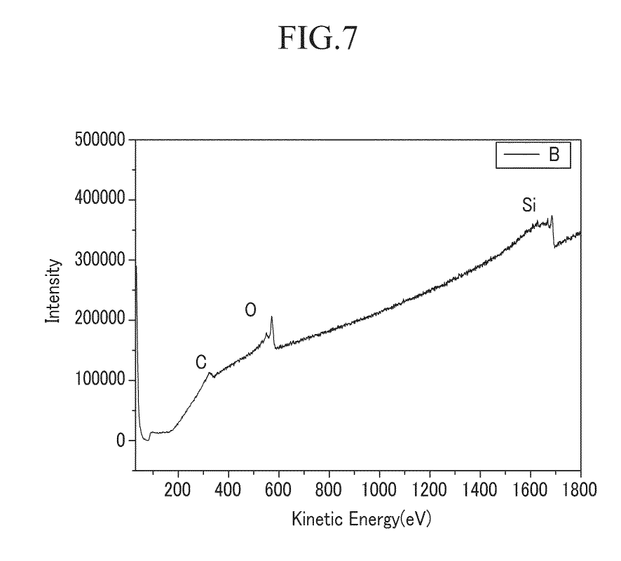

The components on the surface of the silicon wafer according to Example 6 are analyzed using Auger electron spectroscopy (AES) equipment. The result is provided in FIG. 7.

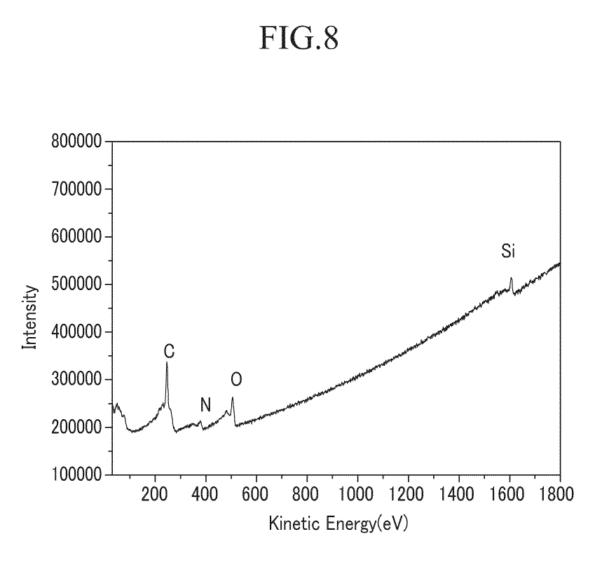

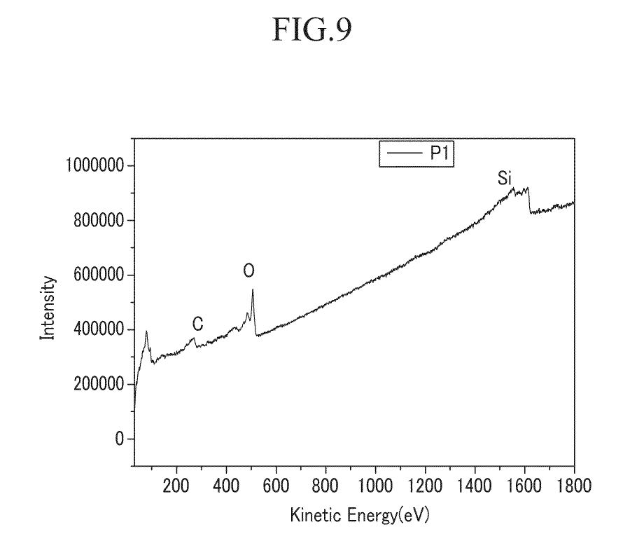

The components on the surface of the insulation layer according to Example 6 are analyzed in an Auger electron spectroscopy (AES) method. The result is provided in FIG. 8. The part A in FIG. 6B is analyzed regarding surface component in an Auger electron spectroscopy (AES) method. The result is provided in FIG. 9.

As shown in FIGS. 7 to 9, an insulation layer is selectively etched in a region coated with the paste of Example 1.

### Experimental Example 5

### Contact Resistance and Resistivity

The electrodes according to Examples 6 to 15 are respectively measured regarding contact resistance and resistivity. The contact resistance and resistivity are measured in a transfer length method (TLM).

Table 1 shows contact resistances and resistivities of the electrodes according to Examples 6, 7, and 10 to 15, and Comparative Examples 3 and 4.

TABLE 1

| | Contact resistance | Resistivity |
|---|---|---|
| | (mΩcm²) | (μΩcm) |
| Example 6 | 191.2 | 6.24 |
| Example 7 | 80.3 | 4.89 |
| Example 10 | 13.3 | 4.12 |
| Example 11 | 6.93 | 3.78 |
| Example 12 | 6.40 | 3.43 |
| Example 13 | 1.93 | 3.03 |
| Example 14 | 20 | 3.32 |
| Example 15 | 8 | 3.12 |
| Comparative Example 3 | 1253 | 6.87 |
| Comparative Example 4 | Not measurable | Not measurable |

Referring to Table 1, the electrodes according to Examples 6, 7, and 10 to 15 have smaller contact resistance than the electrode according to Comparative Example 3. As for Comparative Example 4 having no reverse micelle structure but including a phosphoric acid aqueous solution, an electrode is not fabricated due to phase separation of a paste and is therefore not measured regarding resistance.

An electrode formed using a paste according to example embodiments is selectively patterned in a desired region, and simultaneously has improved properties.

While this disclosure has been described in connection with what is presently considered to be practical example embodiments, it is to be understood that the inventive concepts are not limited to the disclosed embodiments, but, on the contrary, is intended to cover various modifications and equivalent arrangements included within the spirit and scope of the appended claims.

What is claimed is:

1. A paste comprising:
a functional water-soluble material;
a surfactant surrounding the functional water-soluble material to form a reverse micelle structure;
a binder; and
a liposoluble organic solvent.

2. The paste of claim 1, wherein the functional water-soluble material includes one selected from a water-soluble material having an etching property, a water-soluble material having a doping property, a water-soluble fluorescent dye material, a water-soluble conductive polymer material, a water-soluble metal salt, and a combination thereof.

3. The paste of claim 2, wherein the water-soluble material having an etching property includes one selected from phosphoric acid, hydrogen fluoride, sulfuric acid, ammonium fluoride, and a combination thereof.

4. The paste of claim 2, wherein the water-soluble material having a doping property includes one selected from boron salt, boron oxide, boric acid, an organic boron compound, a boron aluminum compound, phosphorous oxide, and a combination thereof.

5. The paste of claim 2, wherein the water-soluble fluorescent dye material includes one selected from a rhodamine dye, an acridine dye, a cyanine dye, a fluorone dye, an oxazine dye, a phenanthridine dye, and a combination thereof.

6. The paste of claim 2, wherein the water-soluble conductive polymer material includes one selected from polyaniline, polythiophene, polypyrrole, a derivative thereof, and a combination thereof.

7. The paste of claim 2, wherein the water-soluble metal salt includes one selected from HAuCl₄, AuCl₃, H₂PtCl₆, FeCl₃, CuCl₂, Zn(OAc)₂, AgNO₃, Ag(OAc), Pb(OAc)₂, CdCl₂, Cd(OAc)₂, and a combination thereof.

8. The paste of claim 1, wherein the reverse micelle structure has an average diameter ranging from about mm to about 10 μm.

9. The paste of claim 1, wherein the reverse micelle structure is in an amount ranging from about 0.1 wt % to about 10 wt % based on the total amount of the paste.

10. The paste of claim 1, wherein the binder includes one selected from a cellulose-based resin, an acryl-based resin, a polyvinylacetal-based resin, a derivative thereof, and a combination thereof.

11. The paste of claim 1, wherein the liposoluble organic solvent includes one selected from N-methylpyrrolidone (NMP), ethylene glycol butyl ether, propylene carbonate, ethylene glycol, N-methyl-2-pyridone, ethylene glycol monoacetate, diethylene glycol, diethylene glycol acetate, tetraethylene glycol, propylene glycol, propylene glycol monomethyl ether, trimethylene glycol, glyceryl diacetate, hexylene glycol, dipropyl glycol, oxylene glycol, 1,2,6-hexanetriol, glycerine, butyl carbitol (BC), butyl carbitol acetate (BCA), methyl cellosolve, ethyl cellosolve, butyl cellosolve, aliphatic alcohol, α-terpineol, β-terpineol, dihydro terpineol, texanol, and a combination thereof.

12. The paste of claim 1, wherein
the surfactant is in an amount ranging from about 30 to about 500 parts by weight,
the binder is in an amount ranging from about 20 to 1000 parts by weight, and
the liposoluble organic solvent is in an amount ranging from about 100 to about 5000 parts by weight based on 100 parts by weight of the functional water-soluble material.

13. The paste of claim 1, further comprising a conductive powder.

14. The paste of claim 13, wherein the reverse micelle structure is on an exposed surface of the conductive powder.

15. The paste of claim 13, wherein the conductive powder includes one selected from silver (Ag), aluminum (Al), copper (Cu), nickel (Ni), tin (Sn), cobalt (Co), palladium (Pd), lead (Pb), alloys thereof, oxides thereof, and a combination thereof.

16. The paste of claim 13, wherein the conductive powder is comprised in an amount ranging from about 30 wt % to about 99 wt % based on a total amount of the paste including the conductive powder.

17. The paste of claim 1, further comprising at least one material selected from glass frit, metallic glass, and a combination thereof.

18. The paste of claim 17, wherein the at least one material selected from glass frit, metallic glass, or a combination thereof is comprised in an amount ranging from about 0.1 wt % to about 15 wt % based on a total amount of the paste including at least one material selected from the glass frit, the metallic glass, or a combination thereof.

19. The paste of claim 1, further comprising a plasticizer.

20. The paste of claim 19, wherein the plasticizer is comprised in an amount ranging from about 0.1 wt % to about 15 wt % based on the total amount of the paste including the plasticizer.

21. The paste of claim 1, wherein the paste is dried at a temperature ranging from about 100° C. to about 400° C.

22. The paste of claim 1, wherein the paste is baked at a temperature ranging from about 500° C. to about 900° C.

23. A method of manufacturing a paste, comprising:
mixing a functional water-soluble material, a surfactant, and a first liposoluble organic solvent in order to form a first mixture, the first mixture including a reverse micelle structure where the functional water-soluble material is surrounded by the surfactant in the first liposoluble organic solvent; and
adding one of a binder and a mixture of the binder and a second liposoluble organic solvent to the first liposoluble organic solvent including the reverse micelle structure to form a second mixture.

24. The method of claim 23, further comprising:
adding a material selected from a conductive powder, a glass frit, a metallic glass, a plasticizer, and a combination thereof to the first liposoluble organic solvent at the same time as the adding one of the binder and the mixture of the binder and the second liposoluble organic solvent.

25. An electronic device comprising at least one of a pattern and an electrode formed using a paste according to claim 1.

26. The electronic device of claim 25, wherein the electrode has contact resistance ranging from about 1 μΩcm² to about 100 cm².

27. The electronic device of claim 25, wherein the electrode has resistivity ranging from about 0.1 μΩcm to about 100 μΩcm.
